(19) United States
(12) Patent Application Publication
(10) Pub. No.: US 2004/0136497 A1
(43) Pub. Date: Jul. 15, 2004

(54) Preparation of samples and sample evaluation

(76) Inventors: Deirdre R. Meldrum, Mercer Island, WA (US); Stewart Turley, Seattle, WA (US); Stephen E. Moody, Woodinville, WA (US); Wim G. J. Hol, Kenmore, WA (US); Charles H. Fisher, Bellevue, WA (US)

Correspondence Address: Delbert J. Barnard, BARNARD, LOOP & McCORMACK LLP, P.O. Box 58888, Seattle, WA, 98138-1888, US

(21) Appl. No.: 10/698,234

(22) Filed: Oct. 30, 2003

Related U.S. Application Data
(60) Provisional application No. 60/422,310, filed on Oct. 30, 2002.

(51) Int. Cl. G01N 23/20

(52) U.S. Cl. 378/79

(57) ABSTRACT

A capillary tube (10) is provided with ends that are initially open. The capillary tube (10) is preferably constructed from a plastic material that will allow the contents of the tube (10) to be analyzed by x-raying the tube (10). Plural fluid segments (20, 28, 30, 32) are introduced into the capillary tube (10) through one end of the tube (10). Then, the ends of the capillary tube (10) are closed, such as fusing them shut (34, 36) or by providing them with closure caps (40, 42). Different capillary tubes (10) contain different combinations of the fluid segments. The contents of each capillary tube (10) forms a distinct sample. The samples are viewed and evaluated while they are in the sealed capillary tubes (10).

### RELATED APPLICATION

This application claims benefit of the filing date of Provisional Application No. 60/422,310, filed Oct. 30, 2002, and entitled Method For Automated Preparation of Capillary Based Samples Protein Crystallography.

### TECHNICAL FIELD

The present invention relates to protein crystallography and similar procedures. More particularly, it relates to a method for preparing samples (e.g. protein crystal samples) sealed within capillary tubes, for use in studies (e.g. x-ray crystallography studies) of substances (e.g. protein crystals) contained in the samples.

### BACKGROUND OF THE INVENTION

The discovery and analysis of the molecular structure of proteins is critical to advancing biochemical knowledge and health science. Protein crystallography by x-ray diffraction is a proven method of assaying protein structure. The preparation of protein crystal samples for crystallography is arduous, time consuming, and labor intensive. For a few protein types, it would generally be necessary to prepare thousands of samples under different conditions in order to discover the optimum conditions for crystal growth. This process is often iterative: first making a broad survey of the parameter space for crystal growth, followed by a finer parameter search around promising points in the multi-dimensional growth parameter space. Once liquid samples are prepared, they must be observed over a period of days, weeks, and months in order to determine which samples are yielding significant crystal formation.

Automation of the crystal sample preparation and evaluation process is important. Forward progress in the field of proteomics is likely to be significantly limited by the ability of researchers to prepare and evaluate samples. Current methods for automation of this process are limited in their flexibility, throughput, degree and extent of automation, and ability to operate on very small initial protein sample volumes. There is a need for a method of preparing samples that provides all of these capabilities simultaneously. It is a principal object of this invention to provide such a method.

### BRIEF SUMMARY OF THE INVENTION

The invention of the present invention is basically characterized by providing a capillary tube having a transparent sidewall; introducing plural fluid segments into the capillary tube; closing the ends of the capillary tube to seal the tube; and evaluating the fluid segments while they are in the sealed tube. Preferably, the capillary tube is a plastic tube. Preferably also, it is constructed from a plastic that will allow the contents of the tube to be analyzed by x-raying the tube.

Once the fluid segments are placed into the capillary tube, the two ends of the capillary tube are closed in any suitable manner. For example, the ends of the capillary tube may be heated and then pinched shut. Or, closure members may be used to close the ends of the tube. One suitable form of closure member is a cap that fits over the end of the capillary tube.

In the preferred embodiment, the fluid segments are injected into the capillary tube through a first end of the tube, such as by use of a piezoelectric dispenser. The second end of the tube may be connected to a vacuum during injection of the fluid segments into the first end of the tube. The vacuum is adjusted to position the fluid segments in the tube.

In preferred form, a chuck may be connected to low levels of vacuum or positive pressure. The vacuum or pressure can be generated by a pump internal to the chuck. The chuck has an end portion adapted to receive the second end of the capillary tube. A plurality of injectors may be provided, each for injecting a different fluid segment. Each capillary tube is moved to place its first end into alignment with a first injector. The first injector is then operated to inject a first fluid segment into the tube. Then, the tube is moved onto a second injector and the second injector is operated to inject a second fluid segment into the tube. The capillary tube is moved in this manner from one injector into another until the tube includes the desired number and kind of the fluid segments. In one embodiment, there is at least one pair of contiguous fluid segments within the sealed capillary tube. In another embodiment, there may be axially spaced fluid segments that are separated by an air gap.

According to the invention, the contents of the tubes are periodically evaluated for the presence of a crystal formation. If the evaluation shows a desirable crystal growth in the tube, the tube and its contents are frozen and then stored in a cold storage. At a later time, the tube is removed from cold storage and there is a crystallography evaluation of the contents of the tube while the contents are in the tube. The evaluation includes x-raying the tube and its contents while the contents remain in the tube.

Other objects, advantages, and features of the invention will become apparent from the description of the best mode set forth below, from the drawings, from the claims, and from the principles that are embodied in the specific structures that are illustrated and described.

### BRIEF DESCRIPTION OF THE SEVERAL VIEWS OF THE DRAWING

Like reference numerals are used to designate like parts throughout the several views of the drawing, and:

FIG. 1 is a schematic view of a portion of the system of the invention, showing a liquid segment being injected into a first end of a capillary tube while the second end of the capillary tube is connected to a vacuum;

FIG. 2 is an enlarged scale longitudinal sectional view of a capillary tube that contains three fluid segments and an air gap in the tube, such view showing the ends of the tube being open;

FIG. 3 views like FIG. 2, but showing the opposite ends of the capillary tube closed at the ends by the tube sidewall material being fused together at the ends of the tube;

FIG. 4 is a view like FIG. 2, but showing four fluid segments and two air gaps;

FIG. 5 is a view like FIG. 4, but showing for example end caps being provided at the opposite ends of the tube for closing the ends of the tube; and

FIG. 6 is a schematic view of the system showing the injection of samples into the capillary tube followed by the various procedures that are conducted on the contents of the tube while it is in tube.

### DETAILED DESCRIPTION OF THE INVENTION

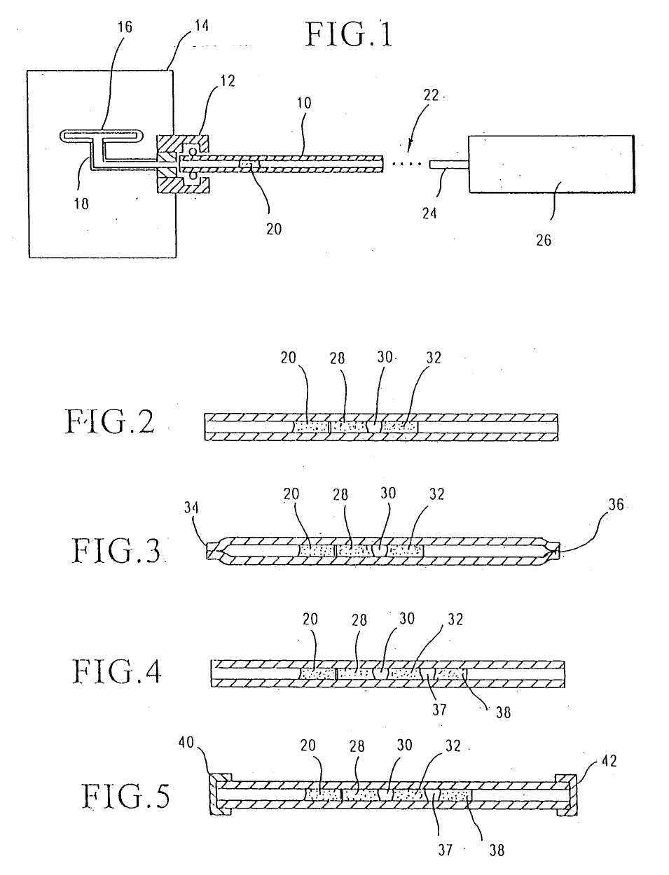

FIG. 1 shows a capillary tube 10 held at one end by a chuck 12. Preferably, the capillary tube 10 has an internal volume of an order 5. The first end of the capillary tube 10 is positioned to receive a fluid segment. The opposite or second end of the capillary tube 10 is held in the chuck 12. An O-ring seal or the like surrounds the first end of the capillary tube 10 and seals between the tube 10 and the chuck 12. The chuck 12 is connected to a housing 14 which contains a low-volume pump, such as a piezoelectric pump 16. Pump 16 is connected to a tube 18 that connects the interior of the capillary tube 10 with the pump 16.

The pump 16 is used for dynamic positioning of the liquid column within the capillary tube 10. FIG. 1 shows a fluid segment 20 in the capillary tube 10. A fluid stream 22 is injected by an injector 24 into the first end of the capillary tube 20 to form the fluid segment 20 in the capillary tube 10. The injector 24 is a part of a piezoelectric micro volume fluid dispenser that includes a piezoelectric driver 26. An injector 24 delivers a fluid segment whose volume can be controlled with very high resolution by the piezoelectric driver 26.

In some cases, the protein crystallography application requires the use of plastic capillary tubes which are hydrophobic. According to a method aspect of the invention, the hydrophobic material requires “coordinated dispensing” of the fluid segments. As the fluid column grows within the capillary tube 10, during filling, the fluid column is continually withdrawn under control of the piezoelectric pump, at such a rate that the end of the column remains flush with the end of the capillary tube 10. This prevents excessive fluid accumulation outside the end of the capillary, as has been observed when hydrophobic capillary materials are used without coordinated dispensing.

Within the capillary format, it is possible to process very small fluid volumes, e.g. 1-2 μl. Protein volumes as low as 50 nanoliters or smaller are practical in the current implementation.

In the preferred embodiment, the chuck 12 is a part of a multiple-chuck array. This allows multiple capillary tubes 10 to be processed in parallel. A typical hardware implementation may include eighteen chucks 12. The system preferably also includes multiple piezoelectric injectors or dispensers 24, 26. By way of example, an installation may include eight injectors 24, 26. The chuck array rotates past a row of injectors 24, 26, in order, so that different reagents can be serially added to each capillary tube 10 on demand. The capillary tube loading subsystem is capable of high throughput repetitive processing of numerous capillary tubes 10. By way of example, a hardware implementation comprising eighteen chucks 12 and eight injectors 24, 26 can process 625 samples per hour.

By appropriate manipulation of the piezoelectric pump 16 it is possible to “stack” subsequent fluid columns within the capillary tube 10, with minimal mixing between the individual fluid segments. It is even possible to add controlled air gaps to the stack of fluid columns. In FIG. 2, distinct liquid segments are designated 20, 28, 32, and an air gap is designated 30. FIG. 4 shows four liquid segments 20, 30, 38, and two air gaps 30, 37 within the capillary tube 10.

The invention allows a wide range of control over diffusion (both liquid and vapor phase) between the various reagent subcolumns. This ability to flexibly tailor the diffusion within the sample is a key advantage of the invention, since diffusion serves as a means to vary the state of the liquid sample over time.

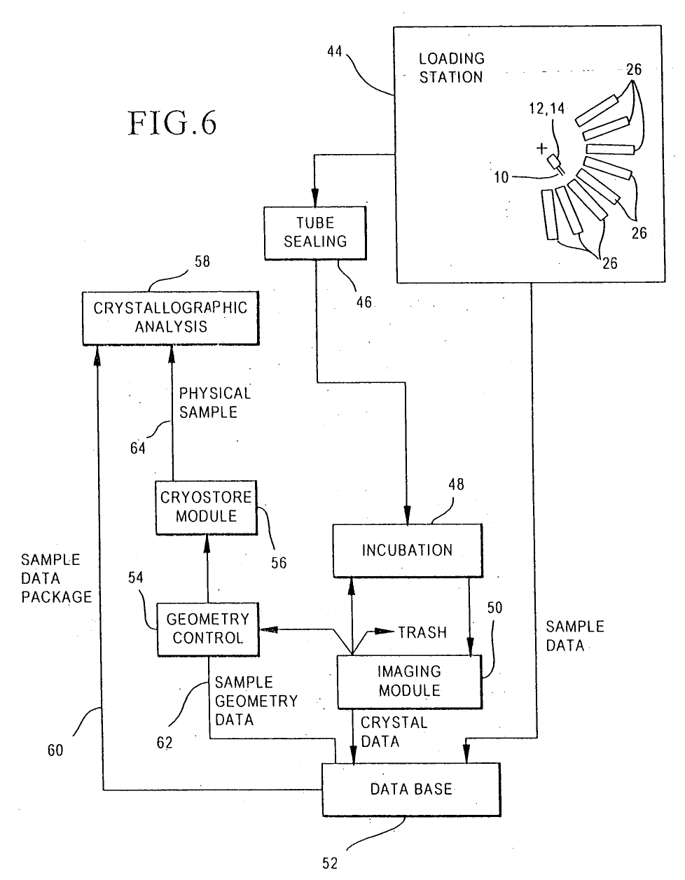

Once samples are made up within the capillary tubes 10, the capillary tubes 10 enter into multistage processing pipeline which may be partially or fully-automated. Fully automated is preferred. This pipeline, shown schematically in FIG. 6 extends from a sample makeup or loading station 44 all the way to the delivery of finished samples to a crystallographic analysis station 58. The following section describes the various stages of this pipeline in greater detail.

After the selected liquid segments are introduced into the capillary tubes 10, the ends of the capillary tubes 10 are closed and sealed in order to eliminate fluid loss due to evaporation. As previously described, the closing or sealing of the ends of capillary tubes 10 can be done in any suitable way. For example, FIG. 3 shows the ends of a capillary tube 10 closed by heat fusion. That is, the ends of the tube 10 are heated and then squeezed or pinched to form end closures 34, 36. FIG. 5 shows the ends of the tube 10 being closed by use of caps 40, 42.

Following closure of the capillary tubes 10, the tubes 10 are preferably robotically transferred to a temperature-controlled “incubator” 48. The sample containing tubes 10 are stored in the incubator 48 for extended times, in anticipation of crystal growth. The incubator 48 is capable of essentially random access to the individual samples. Samples are serially accessed and brought to an image station 50, where high-resolution video images are taken of the entire capillary tube volume. The images are analyzed by high-speed digital signal processing hardware and algorithms, in order to assess the extent of crystal growth within the sample. After imaging, a capillary can be directed to several alternate destinations. It can be returned to the incubator 48 to allow further time for crystal growth to occur. It can be discarded. Finally, successful samples can be taken out of incubation and sent down the remaining pipeline towards crystallographic analysis at station 58. Plastic capillaries which do not show crystals or freeze can also be equilibrated against a low humidity environment which allows evaporization of water through the capillary wall. In other cases, one or both ends of the capillaries might be open allowing water vapor to escape and subsequently closed.

The analysis pipeline begins with a geometric control module 54. This module 54 physically reconstructs the ends of the capillary tubes to a high-precision controlled geometry. This geometry is necessary for accurate location within the crystallographic analysis apparatus 58 (e.g. syncroton). The refinished capillary tube 10 is then flash cooled to cryogenic temperature. It is then re-imaged, in order to provide detailed high-precision data of the three-D location of target crystals, relative to the fiducial surface of a capillary tube 10. Also, the re-imaging may proceed the cooling. Finally, the finished, cooled, measured capillary tube 10 is placed into cryogenic storage 56 in preparation for crystallographic analysis.

The wholly automated pipeline ends where the sample containing tubes 10 are removed from the cryogenic storage module 56.

In addition to the physical hardware for preparing and handling the samples, a critical part of the preferred system of the invention is a database 52, data flow architecture, and accompanying software. Conceptually, each physical sample flowing through the pipeline is accompanied by a data package flowing through the data system. At completion, the data packet will contain initial sample constitution, incubation history, crystal image detection data, and detailed data from the geometric imaging station. This type of integration between physical and data processing is an important factor to a best utilization of the invention.

The primary application currently perceived for the invention is high-throughput preparation of protein crystal samples in advance of crystallography studies. However, the invention is equally applicable to any situation in which diffusion-controlled crystal growth is accomplished from multiple liquid reagents in small volumes. The ability to test many alternate reagents and their effect on the crystallization process is directly applicable to applications and drug discovery and cleaning processes. Improvements and modifications to the basic embodiment of the invention include the use of alternate capillary materials, the use of alternate capillary sealing methods, the use of other types of fluid dispensers for adding and measuring the constituent substances that form the fluid segments. In addition, the single piezoelectric dispenser shown in FIG. 1 can be replaced by a dispenser array having the capacity or capability to move a given dispenser into operation in front of a given capillary tube 10 for a given operation. This capability allows a much larger array of reagents to be handled by the machine. The chuck and piezoelectric pump combination is capable of actively mixing the liquid held within the capillary. It is possible to introduce several reagents, mix them into a single homogenous column, and then add additional reagents in a stratified structure, with the “mixed” reagent being one layer of the structure.

The aforementioned Provisional Application No. 60/422,310 is hereby incorporated herein by this specific reference.

The illustrated embodiments are only examples of the present invention and, therefore, are non-limitive. It is to be understood that many changes in the particular structure, materials and features of the invention may be made without departing from the spirit and scope of the invention. Therefore, it is my intention that my patent rights not be limited by the particular embodiments illustrated and described herein, but rather are to be determined by the following claims, interpreted according to accepted doctrines of patent claim interpretation, including use of the doctrine of equivalents and reversal of parts.

What is claimed is:

1. A method of preparing and handling protein samples for x-ray crystallography studies of protein crystals in the samples, comprising:
providing a capillary tube having a sidewall and open ends;
introducing plural fluid segments into the capillary tube;
closing the ends of the capillary tube to seal the tube; and
viewing and evaluating the fluid segments while they are in the sealed tube.

2. The method of claim 1, wherein said capillary tube is a plastic tube.

3. The method of claim 2, wherein the plastic tube is constructed of a plastic that will allow the contents of the tube to be viewed by x-raying the tube.

4. The method claim 1, wherein the fluid segments include a pair of contiguous fluid segments.

5. The method of claim 1, wherein the fluid segments include a pair of axially spaced fluid segments separated by an air gap.

6. The method of claim 1, comprising closing the ends of the capillary tube by heating and pinching the sidewall of the tube at the ends of the tube.

7. The method of claim 1, comprising closing the ends of the capillary tube by use of closure members that engage the ends of the capillary tube and close the ends of the capillary tube.

8. The method of claim 8, comprising using end closures in the form of caps that slip over the ends of the capillary tube.

9. The method of claim 1, comprising introducing the fluid segments in the capillary tube by injecting them in through a first end of the tube.

10. The method of claim 9, comprising subjecting the second end of the tube to a vacuum during injection of the fluid segments into the first end of the tube.

11. The method of claim 10, comprising providing a chuck connected to the vacuum and an end adapted to receive the second end of the tube.

12. The method of claim 11, comprising sealing between the chuck and the end of the tube.

13. The method of claim 1, comprising introducing the fluid segments in the capillary tube by injecting them in through a first end of the tube, and providing plural ejectors, each ejecting a different fluid segment, and moving the first end of the tube into alignment with a first ejector, and operating the injector to introduce a fluid segment of its fluid into the first end of the tube, and then moving the first end of the tube into alignment with a second injector, and operating the second ejector to inject a fluid segment of its fluid into the first end of the tube.

14. The method of claim 13, comprising moving the capillary tube from injector to injector, into positions to receive successive injections from the injectors.

15. The method of claim 1, comprising storing the capillary tube and its contents after the ends of the tube are closed, and periodically evaluating the contents of the tube for crystal formation while in the tube.

16. The method of claim 15, comprising freezing the contents of the tube while it remains in the tube if the evaluation shows a desirable crystal growth in the contents of the tube.

17. The method of claim 16, comprising placing the tube into cold storage while its contents are frozen and storing it in the cold storage.

18. The method of claim 17, comprising removing the tube and its contents from cold storage and making a crystallography evaluation of the contents while it is in the tube and remained cold.

19. The method of claim 18, comprising x-raying the tube and its contents while the contents remain in the tube.

20. The method of claim 1, wherein the fluid segments are segments of different fluids.

21. The method of claim 20, wherein the fluid segments includes a pair of axially spaced fluid segments that are separated by an air gap.

22. The method of claim 21, comprising connecting the first end of the capillary tube with the source of vacuum and using these vacuums to pull moisture out from the samples before closing the ends of the capillary tube to seal the tube.

23. A method of preparing and handling a reagent sample, comprising:
providing a capillary tube having a sidewall and open ends, introducing one or more fluid segments into one end of the capillary tube;
closing the ends of the capillary tube to seal the tube; and
viewing and evaluating the reagent sample while it is in the sealed tube.

24. The method of claim 23, comprising closing the ends of the capillary tube by heating and pinching the sidewall of the tube at the ends of the tube, to cause the sidewalls to fuse and close the ends of the tube.

25. The method of claim 24, comprising closing the ends of the capillary tube by use of closure members that engage the ends of the capillary tube and close the ends of the capillary tube.
